(19) United States
(12) Patent Application Publication
(10) Pub. No.: US 2026/0269891 A1
(43) Pub. Date: Sep. 10, 2026

(54) EXTENDED CODEBOOK USING PRODUCT LIFTING

(71) Applicant: QUALCOMM Incorporated, San Diego, CA (US)

(72) Inventors: Pinar SEN, San Diego, CA (US); Wei YANG, San Diego, CA (US); Thomas Joseph RICHARDSON, South Orange, NJ (US); Jing JIANG, San Diego, CA (US); Gabi SARKIS, San Diego, CA (US)

(21) Appl. No.: 19/555,526

(22) Filed: Mar. 3, 2026

Related U.S. Application Data
(60) Provisional application No. 63/768,643, filed on Mar. 7, 2025.

(51) Int. Cl. H04B 7/0456; H04L 1/00

(52) U.S. Cl. CPC H04B 7/0456; H04L 1/0057

(57) ABSTRACT

Various aspects of the present disclosure generally relate to wireless communication. In some aspects, a transmitter may generate a signal, for a set of bits, using a codebook, wherein the codebook is based on a quasi-cyclic (QC) low-density parity check (LDPC) code that is associated with a cyclic lifting matrix. The transmitter may transmit the signal using one or more antennas associated with the signal. Numerous other aspects are described.

### CROSS-REFERENCE TO RELATED APPLICATION

This patent application claims priority to U.S. Provisional Patent Application No. 63/768,643, filed on Mar. 7, 2025, entitled “EXTENDED CODEBOOK USING PRODUCT LIFTING,” and assigned to the assignee hereof. The disclosure of the prior application is considered part of and is incorporated by reference into this patent application.

### FIELD OF THE DISCLOSURE

Aspects of the present disclosure generally relate to wireless communication and specifically relate to techniques, apparatuses, and methods associated with communication using an extended codebook generated using product lifting.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

Low-density parity check (LDPC) codes are a type of error-correcting code that is used at the physical (PHY) layer in 5G wireless communication. LDPC codes are used to correct errors that can occur during transmission of data as a result of noise, interference, or channel impairments. In some examples, LDPC codes may be used on a downlink, such as in transmissions by a network node to a user equipment (UE). For example, a transmitter device, such as a network node, may encode data using LDPC codes and transmit the encoded data to a receiver device, such as a UE, via a communication link. The receiver device may decode the encoded data to receive and interpret a communication. LDPC codes may improve a reliability of data transmission over noisy or unreliable channels, thereby ensuring that information can be transmitted more efficiently and with fewer errors than can be achieved by communications that are not encoded with LDPC codes.

### SUMMARY

Some aspects described herein relate to a method of wireless communication performed by a transmitter. The method may include generating a signal, for a set of bits, using a codebook, wherein the codebook is based on a quasi-cyclic (QC) low-density parity check (LDPC) code that is associated with a cyclic lifting matrix. The method may include transmitting the signal using one or more antennas associated with the signal.

Some aspects described herein relate to an apparatus for wireless communication at a transmitter. The apparatus may include one or more memories and one or more processors coupled to the one or more memories. The one or more processors may be configured to generate a signal, for a set of bits, using a codebook, wherein the codebook is based on a QC-LDPC code that is associated with a cyclic lifting matrix. The one or more processors may be configured to transmit the signal using one or more antennas associated with the signal.

Some aspects described herein relate to a non-transitory computer-readable medium that stores a set of instructions for wireless communication by a transmitter. The set of instructions, when executed by one or more processors of the transmitter, may cause the transmitter to generate a signal, for a set of bits, using a codebook, wherein the codebook is based on a QC-LDPC code that is associated with a cyclic lifting matrix. The set of instructions, when executed by one or more processors of the transmitter, may cause the transmitter to transmit the signal using one or more antennas associated with the signal.

Some aspects described herein relate to an apparatus for wireless communication. The apparatus may include means for generating a signal, for a set of bits, using a codebook, wherein the codebook is based on a QC-LDPC code that is associated with a cyclic lifting matrix. The apparatus may include means for transmitting the signal using one or more antennas associated with the signal.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an example disaggregated network node architecture.

FIG. 3 is a diagram illustrating an example of a transmit (Tx) chain and a receive (Rx) chain of a UE.

FIG. 4 is a diagram illustrating an example of network coding.

FIG. 5 is a diagram illustrating an example of network coding.

FIG. 6 is a diagram illustrating an example of quasi-cyclic (QC) low-density parity check (LDPC) codes.

FIG. 7 is a diagram illustrating an example associated with communication using an extended codebook generated with product lifting.

FIG. 8 is a diagram illustrating an example process performed, for example, at a transmitter or an apparatus of a transmitter.

FIG. 9 is a diagram of an example apparatus for wireless communication.

### DETAILED DESCRIPTION

Error correcting codes, such as low-density parity check (LDPC) codes may be used to ensure that error correction can occur in wireless communications systems. Quasi-cyclic (QC) LDPC codes are used in some communications systems to provide high-throughput, reliable communications. For example, a transmitter device, such as a network node, may encode a communication using a QC-LDPC codebook and transmit the encoded communication to a receiver device. The receiver device, such as a user equipment (UE), may receive the encoded communication and decode the encoded communication to recover information conveyed by the communication. As communications systems support higher throughput levels, it may be desirable to have longer codes for encoding a communication.

Various aspects relate generally to generating and using an extended codebook. Some aspects more specifically relate to encoding a communication using a QC-LDPC codebook that is extended using product lifting. In some aspects, a transmitter device may apply product lifting to a QC-LDPC codebook to generate longer LDPC codes while preserving a quasi-cyclic structure of the QC-LDPC codebook. In some aspects, the transmitter device may use a Kronecker product, as described in more detail herein, to generate extended codes for a QC-LDPC codebook. In some aspects, the transmitter device may selectively apply product lifting, to increase a maximum codebook size, based on a quantity of coded bits that are to be generated from LDPC codes.

Particular aspects of the subject matter described in this disclosure can be implemented to realize one or more of the following potential advantages. In some examples, the described techniques can be used to ensure reliable communications at higher throughput rates, such as throughput rates of greater than 100 gigabits per second (Gbps), which may occur with 5G and beyond (e.g., 6G) communications. In some examples, the described techniques can be used to ensure backward compatibility with non-extended (or non product lifted) LDPC codebooks and hardware blocks configured for non-extended (or non product lifted) LDPC codebooks.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

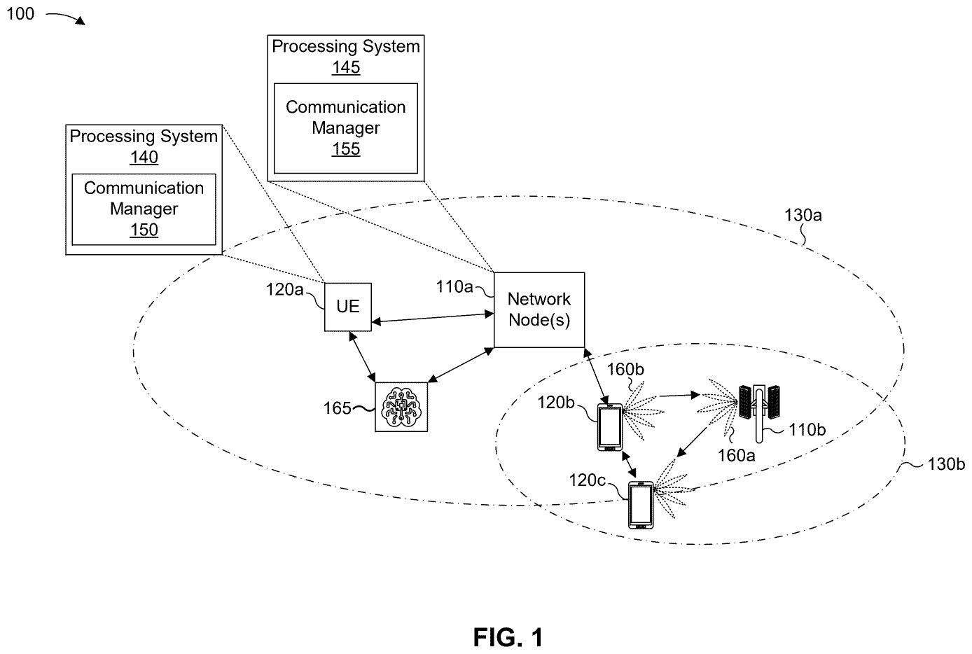

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHZ), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or an LDPC code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the transmitter may include a communication manager 150. As described in more detail elsewhere herein, the communication manager 150 may generate a signal, for a set of bits, using a codebook, wherein the codebook is based on a QC-LDPC code that is associated with a cyclic lifting matrix; and transmit the signal using one or more antennas associated with the signal. Additionally, or alternatively, the communication manager 150 may perform one or more other operations described herein.

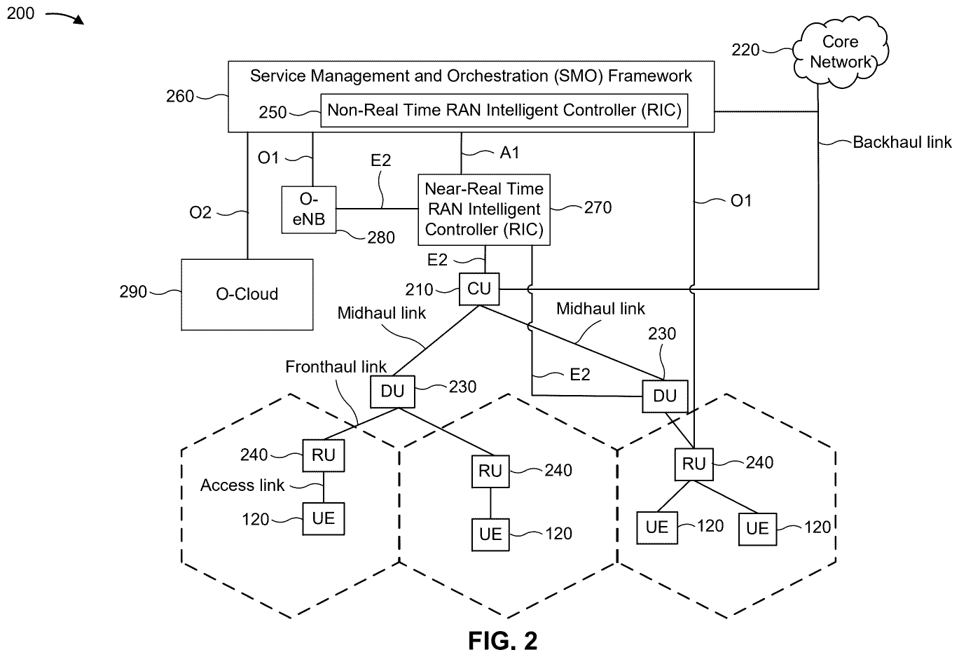

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

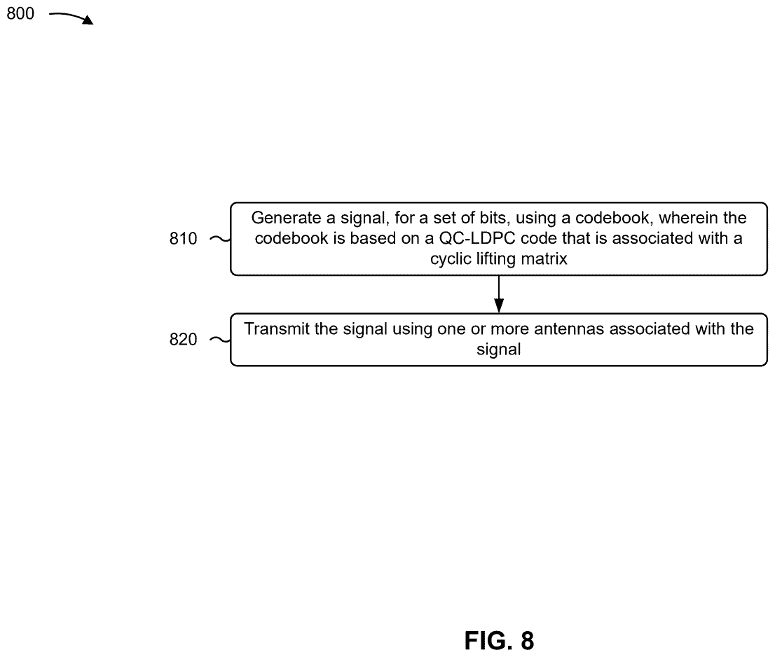

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with communicating using an extended codebook generated using product lifting, as described in more detail elsewhere herein. For example, the processing system 145 of the network node 110, the processing system 140 of the UE 120, the CU 210, the DU 230, or the RU 240 may perform or direct operations of, for example, process 800 of FIG. 8 or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 800 of FIG. 8 or other processes as described herein. In some examples, executing instructions may include running the instructions, converting the instructions, compiling the instructions, or interpreting the instructions, among other examples.

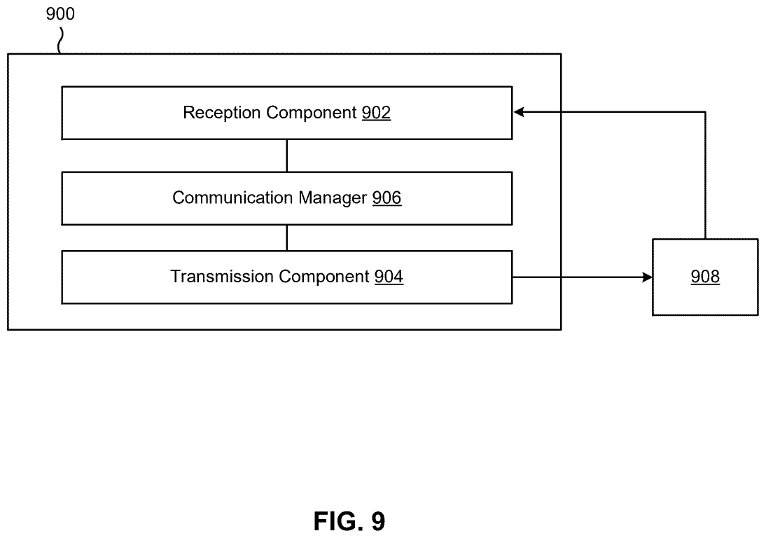

In some aspects, a transmitter device (e.g., a network node 110 or a UE 120) includes means for generating a signal, for a set of bits, using a codebook, wherein the codebook is based on a QC-LDPC code that is associated with a cyclic lifting matrix; or means for transmitting the signal using one or more antennas associated with the signal. In some aspects, the means for the transmitter device to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples. In some aspects, the means for the transmitter device to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

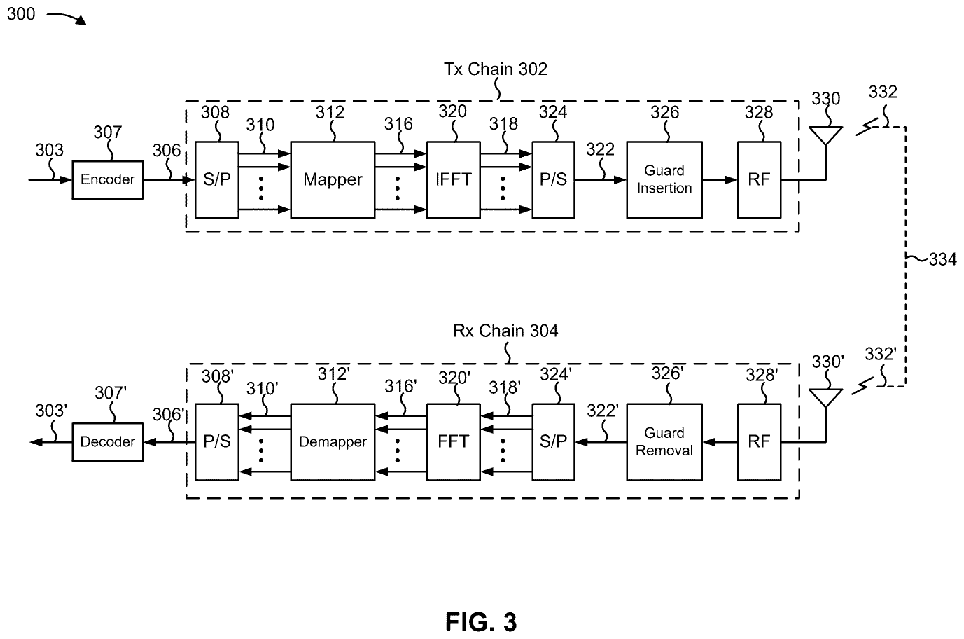

FIG. 3 is a diagram illustrating an example 300 of a transmit (Tx) chain 302 and a receive (Rx) chain 304 of a UE 120. In some examples, one or more components of Tx chain 302 may be implemented in one or more components of a processing system, such as the processing system 140 or the processing system 145 described in connection with FIG. 1. In some examples, Tx chain 302 may be implemented in UE 120 for transmitting data 306 (e.g., uplink data, an uplink reference signal, or uplink control information) to a network node 110 on an uplink channel. In some examples, Tx chain 302 may be implemented in network node 110 for transmitting data 306 (e.g., downlink data, a downlink reference signal, or downlink control information) to a UE 120 on a downlink channel.

An encoder 307 may alter a signal (e.g., a bitstream) 303 into data 306. Data 306 to be transmitted is provided from encoder 307 as input to a serial-to-parallel (S/P) converter 308. In some examples, S/P converter 308 may split the transmission data into N parallel data streams 310.

The N parallel data streams 310 may then be provided as input to a mapper 312. Mapper 312 may map the N parallel data streams 310 onto N constellation points. The mapping may be done using a modulation constellation, such as binary phase-shift keying (BPSK), quadrature phase-shift keying (QPSK), 8 phase-shift keying (8PSK), QAM, etc. Thus, mapper 312 may output N parallel symbol streams 316, each symbol stream 316 corresponding to one of N orthogonal subcarriers of an IFFT component 320. These N parallel symbol streams 316 are represented in the frequency domain and may be converted into N parallel time domain sample streams 318 by IFFT component 320.

In some examples, N parallel modulations in the frequency domain correspond to N modulation symbols in the frequency domain, which are equal to N mapping and N-point IFFT in the frequency domain, which are equal to one (useful) OFDM symbol in the time domain, which are equal to N samples in the time domain. One OFDM symbol in the time domain, Ns, is equal to Ncp (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of guard insertion component 326 may then be upconverted to a desired transmit frequency band by an RF front end 328. An antenna 330 may then transmit the resulting signal 332.

In some examples, Rx chain 304 may utilize OFDM/OFDMA. In some examples, one or more components of Rx chain 304 may be implemented in one or more components of a processing system, such as the processing system 140 or the processing system 145 described in connection with FIG. 1. In some examples, Rx chain 304 may be implemented in UE 120 for receiving data 306 (e.g., downlink data, a downlink reference signal, or downlink control information) from a network node 110 on a downlink channel. In some examples, Rx chain 304 may be implemented in network node 110 for receiving data 306 (e.g., uplink data, an uplink reference signal, or uplink control information) from a UE 120 on an uplink channel.

A transmitted signal 332 is shown traveling over a wireless channel 334 from Tx chain 302 to Rx chain 304. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by guard insertion component 326.

The output of guard removal component 326′ may be provided to an S/P converter 324′. The output may include an OFDM/OFDMA symbol stream 322′, and S/P converter 324′ may divide the OFDM/OFDMA symbol stream 322′ into N parallel time-domain symbol streams 318′, each of which corresponds to one of the N orthogonal subcarriers. An FFT component 320′ may convert the N parallel time-domain symbol streams 318′ into the frequency domain and output N parallel frequency-domain symbol streams 316′.

A demapper 312′ may perform the inverse of the symbol mapping operation that was performed by mapper 312, thereby outputting N parallel data streams 310′. A P/S converter 308′ may combine the N parallel data streams 310′ into a single data stream 306′. Ideally, data stream 306′ corresponds to data 306 that was provided as input to Tx chain 302. Data stream 306′ may be decoded into a decoded data stream 303′ by decoder 307′.

The number and arrangement of components shown in FIG. 3 are provided as an example. In practice, there may be additional components, fewer components, different components, or differently arranged components than those shown in FIG. 3. Furthermore, two or more components shown in FIG. 3 may be implemented within a single component, or a single component shown in FIG. 3 may be implemented as multiple, distributed components. Additionally, or alternatively, a set of components (e.g., one or more components) shown in FIG. 3 may perform one or more functions described as being performed by another set of components shown in FIG. 3.

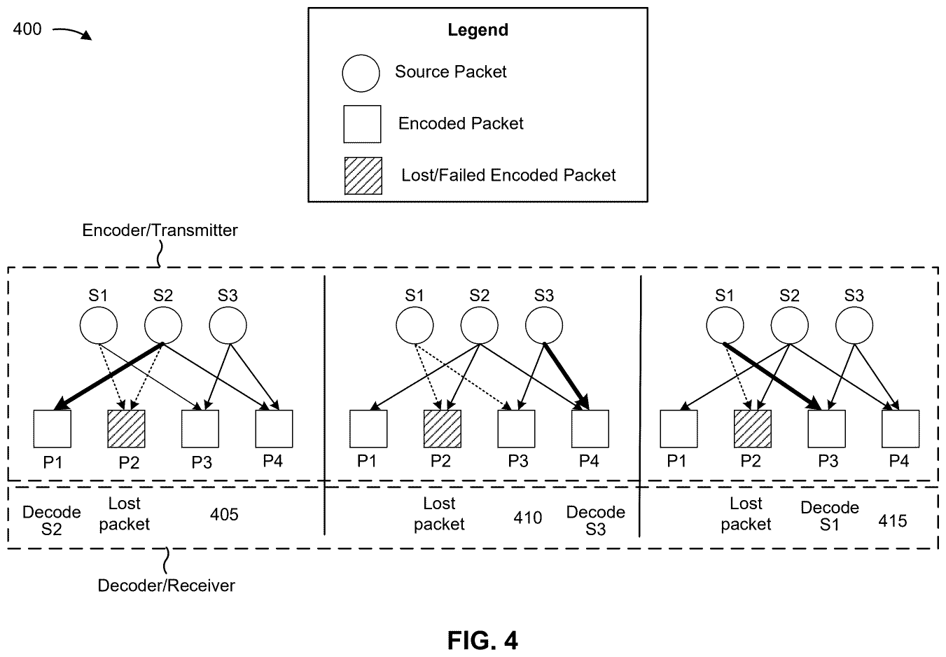

FIG. 4 is a diagram illustrating an example 400 of network coding. Network coding may also be referred to as erasure coding and recovery. As shown in FIG. 4, an encoder (or transmitter) may communicate with a decoder (or receiver). The encoder is sometimes also referred to as a transmitter, an encoder node, or a transmitter node. The encoder may include a UE 120, a network node 110, or an IAB device, among other examples. An IAB device may include an IAB donor (e.g., a CU of an IAB donor or a DU of an IAB donor) or an IAB node (e.g., a DU of an IAB node or a mobile termination (MT) of an IAB node). The decoder is sometimes also referred to as a receiver, a decoder node, or a receiver node. The decoder may include a UE 120, a network node 110, or an IAB device, among other examples.

As shown in FIG. 4, an encoder (or transmitter) may encode data, shown as a set of source packets or original packets (P1, P2, and P3), into a set of encoded packets using network coding. While FIG. 4 uses “packets” as example data, it is understood that the data may include any type of communication (e.g., transport blocks), and is not limited to packets. An encoded packet may be the same as a source packet, may be a redundancy version of a source packet, may include a combination of multiple source packets (e.g., a subset of the source packets), or may include a redundancy version of the combination. The number of encoded packets may be the same as or different than the number of source packets. In some examples, the number of encoded packets may be unlimited (e.g., the encoder may generate any number of encoded packets), such as when using a rateless network coding scheme. In example 400, the encoder encodes K source packets (where K=3) into N encoded packets (where N=4). The encoder transmits the encoded packets to a decoder (or receiver). The decoder uses network coding to decode the encoded packets and recover the source packets. As used herein, network coding may be performed using any type of network coding scheme, such as fountain coding, linear network coding, random linear network coding, Luby transform (LT) network coding, or Raptor network coding, among other examples.

In example 400, the encoder encodes three source packets (S1, S2, and S3) into four encoded packets: P1 (e.g., that carries S2), P2 (e.g., that carries S1+S2), P3 (e.g., that carries S1+S3), and P4 (e.g., that carries S2+S3). The encoder may transmit the four encoded packets to the decoder. In this example, the packet P2 (carrying S1+S2) is not successfully received by the decoder. In a first operation 405, the decoder decodes the packet P1 (carrying S2). In a second operation 410, the decoder obtains S3 from the packet P4 (carrying S2+S3) because the decoder has already decoded S2 and can use combining to obtain S3 from S2+S3. In a third operation 415, the decoder obtains S1 from the packet P3 (carrying S1+S3) because the decoder has already decoded S3 and can use combining to obtain S1 from S1+S3. In some examples, an encoded packet may include an indication (e.g., in a header of the encoded packet) that indicates the source packet(s) that are included in the encoded packet. Thus, the decoder can obtain S1, S2, and S3 despite P2 failing, and using less overhead than PDCP duplication. For example, PDCP duplication may duplicate all of the source packets for a total of six transmissions, while the example network coding shown in FIG. 4 uses four transmissions.

In some cases, the encoder may continue to transmit encoded packets (e.g., the same combination of encoded packets or different combinations of encoded packets) to the decoder until the encoder receives a notification from the decoder. For example, the decoder may successfully receive the source packets or may abort decoding, which may trigger the decoder to send a notification to the encoder. The notification may include, for example, an ACK or a stop message (STOP). In some cases, the decoder may transmit an ACK for each original packet that is successfully received. Additionally, or alternatively, the decoder may transmit an ACK upon successful reception of all of the source packets. Upon receiving the notification, the encoder may encode additional data (e.g., a new set of source packets, such as S4, S5, and S6), and may transmit encoded packets to the decoder, in a similar manner as described above, until all of the data has been transmitted or successfully received. Alternatively, to conserve network resources and reduce overhead, the encoder may not transmit an ACK or a NACK for received packets.

In some cases, such as when using a Raptor network coding scheme, the encoder may perform inner coding, or precoding, to generate a set of intermediate packets, that include a set of redundant packets, from the source packets. A redundant packet may be a copy of a source packet or a redundancy version of a source packet. In some examples, a redundant packet may be an LDPC packet. For example, the encoder may apply inner coding to generate K′ intermediate packets (e.g., original plus redundant packets from K source packets). The encoder may then perform outer coding (e.g., fountain coding or LT network coding) to generate N encoded packets from the K′ intermediate packets, in a similar manner as described above. As a result, the encoding or decoding complexity of the Raptor network coding scheme may be linear. The encoded packets may include a set of systemic packets and a set of repair packets. In some examples, the decoder may choose to not decode a packet included in the set of systematic symbols that has a high decoding complexity (e.g., is associated with a high encoding degree or is associated with a high quantity of source packets). The decoder may recover the source packets associated with the packet that is not decoded from one or more packets included in the set of repair packets. The one or more packets included in the set of repair packets may be associated with a lower decoding complexity. As a result, the decoding complexity may be reduced.

In some examples, the network coding may be viewed as a linear system (e.g., over a Galois field) with three variables and four linearly independent constraints. For example, the three variables may correspond to the source packets (e.g., S1, S2, and S3) and the four linearly independent constraints may correspond to the four encoded packets. Using the linear system, any of the three variables that have been subject to an erasure (e.g., transmission error) may be recovered based at least in part on a portion of the three original packets and based at least in part on a portion of the four encoded packets. Network coding (e.g., erasure coding and recovery) may enable a UE to recover a communication that has been erased (e.g., lost or corrupted) during transmission. The recovery of the erased communication, without requiring retransmission by the network node, may reduce the overall number of retransmissions by the network node and may reduce the overall load on the network.

As indicated above, FIG. 4 is provided as an example of network coding. Other examples of network coding may differ from what is described with regard to FIG. 4.

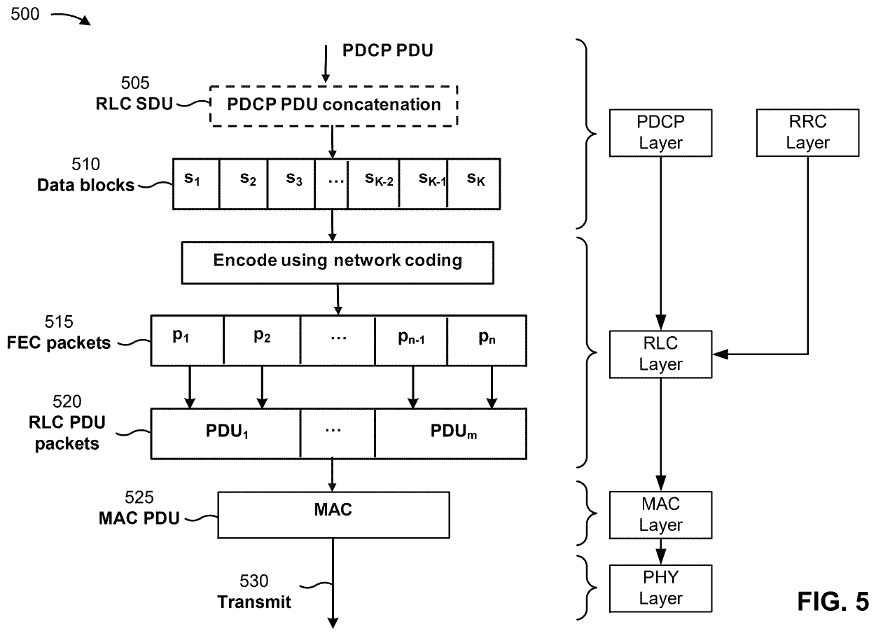

FIG. 5 is a diagram illustrating an example 500 of network coding. The operations described in connection with FIG. 5 may be performed by a transmitter (also referred to as an encoder), such as a UE 120 or a network node 110.

As shown by reference number 505, a transmitter may generate an RLC service data unit (SDU) from one or more PDCP protocol data units (PDUs). In some examples, a single PDCP PDU is included in an RLC SDU. In some examples, multiple PDCP PDUs are included in an RLC SDU (e.g., by concatenating multiple PDCP PDUs). In some examples, the transmitter determines whether to include a single PDCP PDU in a single RLC SDU or whether to concatenate multiple PDCP PDUs in a single RLC SDU based at least in part on a size of the PDCP PDU. For example, if the size of the PDCP PDU satisfies a threshold (e.g., is greater than or equal to the threshold), then the encoder may include only the PDCP PDU (e.g., a single PDCP PDU) in a single RLC SDU. If the size of the PDCP PDU does not satisfy a threshold (e.g., is less than or equal to the threshold), then the encoder may concatenate multiple PDCP PDUs (e.g., a set of PDCP PDUs with a total size that is less than or equal to the threshold) into a single RLC SDU.

As shown by reference number 510, the transmitter may divide the RLC SDU into a plurality of data blocks. For example, the transmitter may divide the RLC SDU into K data blocks, shown as s₁ through s_{K}, based at least in part on the set of network coding parameters. In some examples, the set of network coding parameters specify the value of K for a particular set of sub-parameters, such as a payload size for the RLC SDU or a size of a sequence number field in an RLC PDU header for the RLC SDU. In some examples, the encoder determines the value of K for a set of sub-parameters.

In some examples, the operations associated with reference number 505 and 510 may be performed at the PDCP layer of the transmitter. The PDCP layer may provide the data blocks to the RLC layer of the transmitter. As shown by reference number 515, the transmitter may encode the K data blocks into N FEC packets using network coding. For example, the transmitter may encode the K data blocks into the N FEC packets, shown as p₁ through p_{N}, based at least in part on a rateless code, such as a network code, a fountain code, an LT code, or a Raptor code. In particular, the transmitter may encode the K data blocks into the N FEC packets such that the N FEC packets include additional information or bits for purposes of forward error correction. This permits FEC packets to be recovered by a receiver, for example, if the quantity of received FEC packets is larger than the quantity of K data blocks regardless of which FEC packets are received.

In some examples, the number of RLC packets (e.g., the value of N) is based at least in part on the set of network coding parameters. In some examples, the set of network coding parameters specifies the value of N for a particular set of sub-parameters, a delay budget for the RLC SDU, available encoding and decoding computation resources of the transmitter, the value of K (e.g., the quantity of data blocks), a target error probability for one or more RLC PDU packets for the N FEC, channel conditions for transmission of the RLC PDU packets(s), or the type of network code that is to be used to encode the K data blocks into the N FEC packets, among other examples. In some examples, the transmitter may determine the value of N for a set of sub-parameters.

As shown by reference number 520, the transmitter may map the N FEC packets to a corresponding M RLC PDU packets. For example, the transmitter may map N FEC packets to M RLC PDU packets, shown as PDU₁ through PDU_{M}, such that each RLC PDU includes a plurality of FEC packets (e.g., two FEC packets per RLC PDU packet, four FEC packets per RLC PDU packet, or another quantity of FEC packets per RLC PDU packet). In some examples, the operations associated with reference number 515 and 520 are performed at the RLC layer of the transmitter. The RLC layer may receive an indication of the set of network coding parameters from the RRC layer and may perform the operations associated with reference number 515 and 520 based at least in part on the set of network coding parameters.

The RLC layer may provide the M RLC PDU packets to the MAC layer of the transmitter. As shown by reference number 525, the transmitter may generate a MAC PDU for the M RLC PDU packets. In some examples, the MAC PDU includes an RLC PDU header or a MAC PDU header, which may include information associated with each of the M RLC PDUs. For example, the RLC PDU header or MAC PDU header may include a sequence number field, which may indicate a sequence number associated with each of the M RLC PDUs. In some examples, the operations associated with reference number 525 are performed at the MAC layer of the transmitter.

The MAC layer of the transmitter may provide the MAC PDU to the physical (PHY) layer of the transmitter. As shown by reference number 530, the encoder may transmit the M RLC PDU packets (e.g., in the MAC PDU) to a receiver (also referred to as a decoder), such as a UE 120 or a network node 110. In some examples, the PHY layer of the transmitter may transmit the M RLC PDU packets (e.g., in the MAC PDU) over a wireless physical channel, such as a PDSCH, a PDCCH, a PUSCH, a PUCCH, a physical sidelink control channel (PSCCH), or a physical sidelink shared channel (PSSCH).

As indicated above, FIG. 5 is provided as an example. Other examples may differ from what is described with respect to FIG. 5.

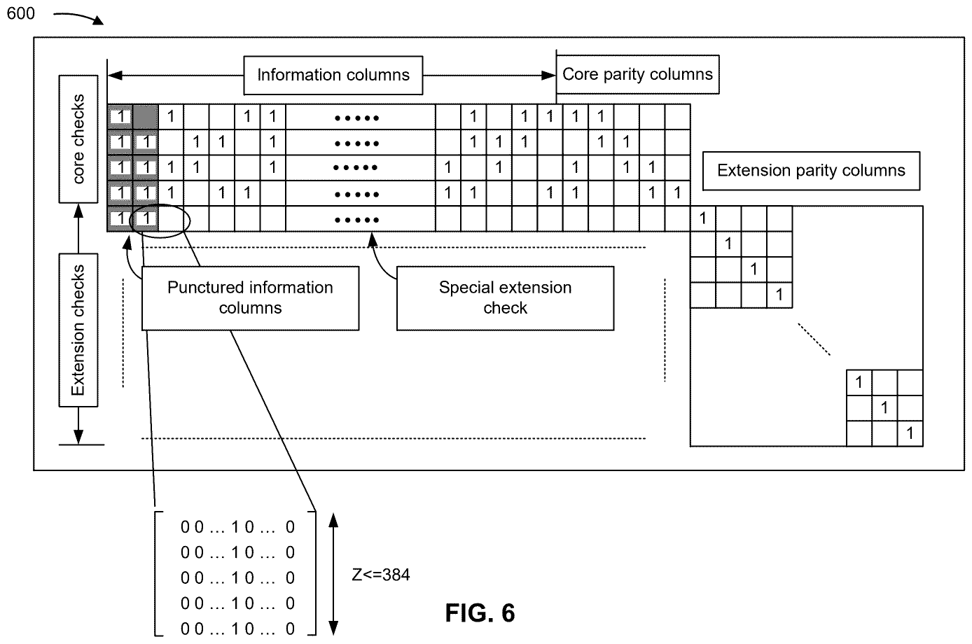

FIG. 6 is a diagram illustrating an example 600 of QC-LDPC codes. The operations described in connection with FIG. 6 may be performed by a transmitter (also referred to as an encoder), such as a UE 120 or a network node 110.

A QC-LDPC code may be represented with a base graph (BG) and a set of liftings. The base graph may include a graph that describes a macroscopic property of the QC-LDPC code (e.g., a protograph). The base graph may be represented by a matrix (which may be termed a “base matrix”) that includes a set of columns denoting variable nodes of the base graph and a set of rows denoting check nodes of the base graph. The liftings represent entries of the base matrix, which are lifted by a circulant identity matrix. The circulant, of the circulant identity matrix, represents an integer in non-zero entries of the base graph matrix (e.g., a cyclic shift). Each variable node of the base graph can be associated with a set of Z coded bits from the LDPC codes. A degree of a variable node represents a quantity of check nodes that a variable node is connected to within the base graph. In other words, the degree of the variable node represents a quantity of edges (e.g., ‘1’s) in a column of the base graph. When lifting is applied, the lifting preserves a degree distribution of each coded bit.

In FIG. 6, a base parity check structure for 5G NR LDPC code is provided. Here, a parity check matrix includes a set of columns, which include information columns, core parity columns, and extension parity columns. The information columns may correspond to data bits or information bits of the code relating to data that is to be transmitted. The core parity columns may represent parity bits that are generated from the information bits. Further, the parity check matrix includes a set of rows, which include core check rows and extension check rows. The extension parity columns and the extension check rows form an identity matrix. A total block length of the LDPC code is a product of the base graph size and a lift value Z. The lift value Z corresponds to a dimension of the identity matrix Z×Z, which is used in connection with lifting entries of the base matrix, as described in more detail herein.

As indicated above, FIG. 6 is provided as an example. Other examples may differ from what is described with respect to FIG. 6.

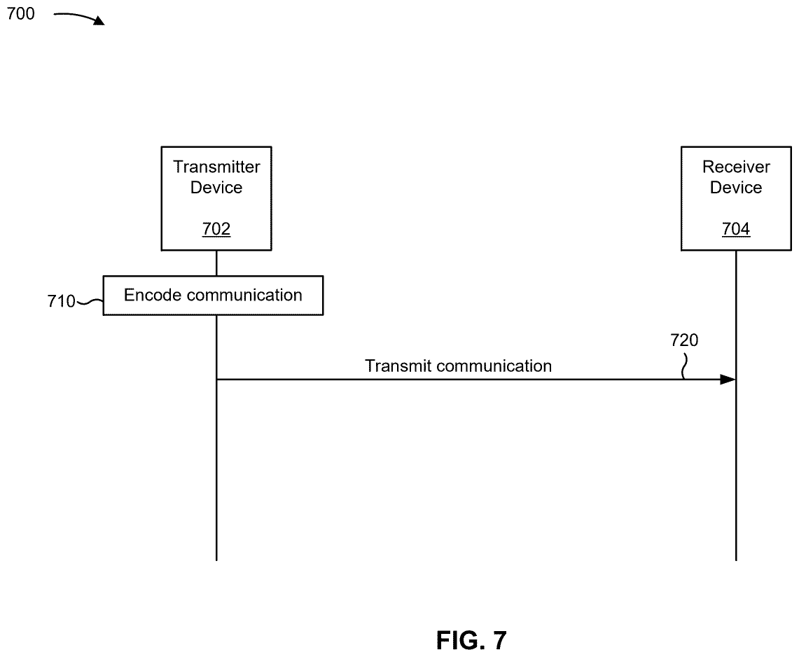

FIG. 7 is a diagram illustrating an example 700 associated with communication using an extended codebook generated with product lifting. As shown in FIG. 7, example 700 includes communication between a transmitter device 702 (e.g., a network node 110 or a UE 120) and a receiver device 704 (e.g., a UE 120 or a network node 110).

As further shown in FIG. 7, and by reference number 710, the transmitter device 702 may encode a communication. For example, the transmitter device 702 may generate a signal for transmission, which may include encoding data of a communication using a codebook. In some aspects, the transmitter device 702 may use a product-lifted codebook. For example, the transmitter device 702 may apply product lifting to a codebook (e.g., a QC-LDPC codebook) to generate an extended codebook, as described herein. In some aspects, the transmitter device 702 may select the product-lifted codebook based on a configured maximum codebook size. For example, when a maximum codebook size is to be larger than a codebook size of a QC-LDPC codebook, the transmitter device 702 may apply product lifting to extend the QC-LDPC codebook. In some aspects, the transmitter device 702 may apply product lifting based on a threshold. For example, when a lift value Z is to be larger than a threshold lift value (e.g., 384), the transmitter device 702 may apply product lifting using a Kronecker product, as described herein. Additionally, or alternatively, when the lift value is not greater than the threshold, the transmitter device 702 may use another technique for codebook generation or extension, such as modulo lifting. In some aspects, the transmitter device 702 may determine a lifting value and may select a lifting structure (e.g., product lifting or another technique) based on the lifting value.

In some aspects, the transmitter device 702 may use a QC-LDPC codebook with a base graph that is lifted using product lifting. For example, the transmitter device 702 may use an extended codebook to encode data of a communication. In some aspects, the transmitter device 702 may generate (or access a generated) extended codebook. For example, for each edge of a base graph there is a Z×Z cyclic lifting matrix. To generate an extended codebook, a Kronecker product is obtained for the Z×Z cyclic lifting matrix and an identity matrix with a cyclic shift value. For a double length codebook, the cyclic shift value may be 0 or 1, such that a 2×2 cyclic shifted identity matrix takes the form of:

$$[ \begin{matrix}1 & 0 \\ 0 & 1\end{matrix} ] : for cyclic shift = 0 , or$$

$$[ \begin{matrix}0 & 1 \\ 1 & 0\end{matrix} ] : for cyclic shift = 1.$$

Here, cyclically permuted versions of the 2×2 identity matrix may be used for the Kronecker product, as described herein to achieve a doubled extended codebook. In some examples, the identity matrix for cyclic shift=0 may be termed “the identity matrix” and an identity matrix with cyclic shift≠0 may be termed “a skew-identity matrix.” In another example, for a quadruple length codebook, the cyclic shift value may be 0, 1, 2, or 3, such that a 4×4 cyclic shifted identity matrix takes the form of:

$$[ \begin{matrix}1 & 0 & 0 & 0 \\ 0 & 1 & 0 & 0 \\ 0 & 0 & 1 & 0 \\ 0 & 0 & 0 & 1\end{matrix} ] : for cyclic shift = 0 ,$$

$$[ \begin{matrix}0 & 1 & 0 & 0 \\ 0 & 0 & 1 & 0 \\ 0 & 0 & 0 & 1 \\ 1 & 0 & 0 & 0\end{matrix} ] : for cyclic shift = 1 ,$$

$$[ \begin{matrix}0 & 0 & 1 & 0 \\ 0 & 0 & 0 & 1 \\ 1 & 0 & 0 & 0 \\ 0 & 1 & 0 & 0\end{matrix} ] : for cyclic shift = 2 , or$$

$$[ \begin{matrix}0 & 0 & 0 & 1 \\ 1 & 0 & 0 & 0 \\ 0 & 1 & 0 & 0 \\ 0 & 0 & 1 & 0\end{matrix} ] : for cyclic shift = 3 .$$

Here, for the 4×4 cyclic shifted identity matrix may be a set of cyclic shifted permuted versions of the 4×4 identity matrix (e.g., which corresponds to cyclic shift=0), with each edge being replaced by a 4×4 matrix. In some aspects, cyclic shift values for the quadrupled extended codebook may be configured based on an optimization of a set of overall cycle properties of a whole base graph. Although some aspects are described in terms of a doubled extended (2X-extended) codebook and a quadrupled extended (4X-extended) codebook, other values for an MX-extended are contemplated.

The Kronecker product may represent a matrix operation that combines a first matrix A, which is an m×n matrix, and a second matrix B, which is a p×q matrix, such that:

$$A ⊗ B = [ \begin{matrix}{a}_{11} B & … & {a}_{1 n} B \\ ⋮ & ⋱ & ⋮ \\ {a}_{m 1} B & … & {a}_{mn} B\end{matrix} ] = [ \begin{matrix}{a}_{11} {b}_{11} & … & {a}_{1 n} {b}_{1 q} \\ ⋮ & ⋱ & ⋮ \\ {a}_{m 1} {b}_{p 1} & … & {a}_{mn} {b}_{pq}\end{matrix} ]$$

where, for an extended QC-LDPC codebook, A represents the Z×Z cyclic lifting matrix and B represents the cyclic shifted identity matrix. Based on taking the Kronecker product, the transmitter device 702 may generate a lifted graph. In some aspects, an order of the Kronecker product may result in a particular lifted graph. In a first example, the transmitter device 702 may take each edge of a base matrix and replace the edge with a 2Z×2Z cyclic shift matrix that is obtained by a Kronecker product of CS₁ ⊗CS₂, where CS₁ represents an original Z×Z matrix and CS₂ represents a 2×2 cyclic shifted identity matrix for doubling a size of Zmax, which represents a length of a codebook. Accordingly, the transmitter device 702 takes each edge of a lifted graph and replaces each edge with a 2×2 cyclic shifted matrix with a cyclic shift value of 0 or 1 (for a 2X-extended codebook). In a second example, the transmitter device 702 may use a Kronecker product of CS₂ ⊗CS₁. Accordingly, the transmitter device 702 takes each edge of a base graph and replaces each edge with a 2×2 matrix (e.g., with a cyclic shift value of 0 or 1) and then applies lifting again on a resulting set of edges with CS₁, thereby replacing each edge in a resulting 2×2 matrix with CS₁. In some aspects, the transmitter device 702 may have a matrix with no edges, corresponding to a 0 in a base graph, and may replace such an edge with a −1 matrix of a corresponding size. Accordingly, for a CS value of CS₁=30 and where CS₂ is the identity matrix, the transmitter device 702 may generate an overall cyclic shifted matrix of:

$$[ \begin{matrix}30 & - 1 \\ - 1 & 30\end{matrix} ] .$$

In some aspects, the transmitter device 702 may generate an extended codebook for HARQ feedback. For example, the transmitter device 702 may use identity matrix based lifting for degree-1 HARQ extension nodes. Similarly, for a degree-2 chain of a codebook with a cyclic shift of 0, the transmitter device 702 may use an identity matrix (e.g., a 2×2 or 4×4 identity matrix, among other examples) for codebook extension. In some aspects, for a degree-2 chain of a codebook, the transmitter device 702 may select an identity matrix as CS₂ for each 0 cyclic shift value in the degree-2 chain. In this case, the transmitter device 702 may select the same matrix as CS₂ for ‘1’s in a first parity column for occurrences where there are an even quantity of ‘1’s. This avoids a pair of ‘1’s cancelling when a row is summed to generate a parity determination.

As further shown in FIG. 7, and by reference number 720, the transmitter device 702 may transmit, to the receiver device 704, the communication. For example, based on encoding a communication using a product lifted, extended codebook (e.g., a QC-LDPC extended codebook), the transmitter device 702 may transmit the encoded communication. In some aspects, the transmitter device 702 may transmit configuration information. For example, the transmitter device 702 may transmit, in connection with the encoded communication or as a separate communication from the encoded communication, an indication of encoding used for the communication. For example, the transmitter device 702 may configure the receiver device 704 with an indication of a type of encoding used for the communication, such as an indication that the communication is encoded using a QC-LDPC codebook.

As indicated above, FIG. 7 is provided as an example. Other examples may differ from what is described with respect to FIG. 7.

FIG. 8 is a diagram illustrating an example process 800 performed, for example, at a transmitter or an apparatus of a transmitter. Example process 800 is an example where the apparatus or the transmitter (e.g., a network node 110 or a UE 120) performs operations associated with extended codebook using product lifting.

As shown in FIG. 8, in some aspects, process 800 may include generating a signal, for a set of bits, using a codebook, wherein the codebook is based on a QC-LDPC code that is associated with a cyclic lifting matrix (block 810). For example, the transmitter (e.g., using communication manager 906, depicted in FIG. 9) may generate a signal, for a set of bits, using a codebook, wherein the codebook is based on a QC-LDPC code that is associated with a cyclic lifting matrix, as described above.

As further shown in FIG. 8, in some aspects, process 800 may include transmitting the signal using one or more antennas associated with the signal (block 820). For example, the transmitter (e.g., using transmission component 904 or communication manager 906, depicted in FIG. 9) may transmit the signal using one or more antennas associated with the signal, as described above.

Process 800 may include additional aspects, such as any single aspect or any combination of aspects described below or in connection with one or more other processes described elsewhere herein.

In a first aspect, the codebook is based on a matrix direct product of the cyclic lifting matrix and an identity matrix with a configured cyclic shift value.

In a second aspect, alone or in combination with the first aspect, the identity matrix is a 2×2 identity matrix and, the configured cyclic shift value is 0 or 1.

In a third aspect, alone or in combination with one or more of the first and second aspects, wherein the identity matrix is a 4×4 identity matrix, and wherein the configured cyclic shift value is 0, 1, 2, or 3.

In a fourth aspect, alone or in combination with one or more of the first through third aspects, wherein the identity matrix is a 2^{M}×2^{M} identity matrix, wherein the configured cyclic shift value is in a range of 0 to (2^{M})−1, and wherein M represents a configured extension multiplier of the codebook.

In a fifth aspect, alone or in combination with one or more of the first through fourth aspects, the matrix direct product is a Kronecker product.

In a sixth aspect, alone or in combination with one or more of the first through fifth aspects, wherein the codebook is based on a replacement of an edge of a base matrix with a lifting replacement matrix, wherein the lifting replacement matrix is associated with a base graph lifted in connection with an initial cyclic lifting matrix.

In a seventh aspect, alone or in combination with one or more of the first through sixth aspects, the lifting replacement matrix is based on the base matrix and a cyclic shifted matrix.

In an eighth aspect, alone or in combination with one or more of the first through seventh aspects, the codebook is based on a first replacement of a first edge of a base matrix with a first lifting replacement matrix to generate an intermediate matrix and a second replacement of a second edge of the intermediate matrix with a second lifting replacement matrix.

In a ninth aspect, alone or in combination with one or more of the first through eighth aspects, the codebook is based on the cyclic lifting matrix in connection with a configured maximum codebook size.

In a tenth aspect, alone or in combination with one or more of the first through ninth aspects, the codebook is based on the cyclic lifting matrix in connection with a matrix dimension size satisfying a threshold.

In an eleventh aspect, alone or in combination with one or more of the first through tenth aspects, the cyclic shift value of the cyclic lifting matrix is 0, and wherein the cyclic lifting matrix is an identity matrix.

In a twelfth aspect, alone or in combination with one or more of the first through eleventh aspects, the codebook is associated with a degree-2 chain, and wherein the cyclic lifting matrix is an identity matrix for 0 cyclic shift values in the degree-2 chain and is the identity matrix for 1 values in a parity column associated with the codebook.

In a thirteenth aspect, alone or in combination with one or more of the first through twelfth aspects, wherein the codebook is associated with a degree-2 chain, and wherein the cyclic lifting matrix is an identity matrix for 0 cyclic shift values in the degree-2 chain and is the cyclic lifting matrix for non-zero values in a base graph that is assigned to the same initial matrix in connection with product lifting.

In a fourteenth aspect, alone or in combination with one or more of the first through thirteenth aspects, wherein the codebook is associated with a degree-1 hybrid automatic repeat request extension node, and wherein the codebook is associated with an identity matrix for product lifting.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication. The apparatus 900 may be a transmitter (e.g., a network node 110 or a UE 120), or a transmitter may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 150 or the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 or the processing system 145 described in connection with FIG. 1) of the transmitter.

In some aspects, the apparatus 900 may be configured to perform one or more operations described herein in connection with FIG. 7. Additionally, or alternatively, the apparatus 900 may be configured to perform one or more processes described herein, such as process 800 of FIG. 8. In some aspects, the apparatus 900 or one or more components shown in FIG. 9 may include one or more components of the transmitter described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the transmitter described above in connection with FIG. 1, such as a radio, one or more RF chains, one or more transceivers, or one or more modems, each of which may in turn be coupled with one or more antennas of the transmitter.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the transmitter described above in connection with FIG. 1, such as a radio, one or more RF chains, one or more transceivers, or one or more modems, each of which may in turn be coupled with one or more antennas of the transmitter described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The communication manager 906 may generate a signal, for a set of bits, using a codebook, wherein the codebook is based on a QC-LDPC code that is associated with a cyclic lifting matrix. The transmission component 904 may transmit the signal using one or more antennas associated with the signal.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a transmitter, comprising: generating a signal, for a set of bits, using a codebook, wherein the codebook is based on a quasi-cyclic (QC) low-density parity check (LDPC) code that is associated with a cyclic lifting matrix; and transmitting the signal using one or more antennas associated with the signal.

Aspect 2: The method of Aspect 1, wherein the codebook is based on a matrix direct product of the cyclic lifting matrix and an identity matrix with a configured cyclic shift value.

Aspect 3: The method of Aspect 2, wherein the identity matrix is a 2×2 identity matrix and, wherein the configured cyclic shift value is 0 or 1.

Aspect 4: The method of Aspect 2, wherein the identity matrix is a 4×4 identity matrix, and wherein the configured cyclic shift value is 0, 1, 2, or 3.

Aspect 5: The method of Aspect 2, wherein the identity matrix is a 2^{M}×2^{M} identity matrix, wherein the configured cyclic shift value is in a range of 0 to (2^{M})−1, and wherein M represents a configured extension multiplier of the codebook.

Aspect 6: The method of Aspect 2, wherein the matrix direct product is a Kronecker product.

Aspect 7: The method of any of Aspects 1-6, wherein the codebook is based on a replacement of an edge of a base matrix with a lifting replacement matrix, wherein the lifting replacement matrix is associated with a base graph lifted in connection with an initial cyclic lifting matrix.

Aspect 8: The method of Aspect 7, wherein the lifting replacement matrix is based on the base matrix and a cyclic shifted matrix.

Aspect 9: The method of any of Aspects 1-8, wherein the codebook is based on a first replacement of a first edge of a base matrix with a first lifting replacement matrix to generate an intermediate matrix and a second replacement of a second edge of the intermediate matrix with a second lifting replacement matrix.

Aspect 10: The method of any of Aspects 1-9, wherein the codebook is based on the cyclic lifting matrix in connection with a configured maximum codebook size.

Aspect 11: The method of any of Aspects 1-10, wherein the codebook is based on the cyclic lifting matrix in connection with a matrix dimension size satisfying a threshold.

Aspect 12: The method of any of Aspects 1-11, wherein the cyclic shift value of the cyclic lifting matrix is 0, and wherein the cyclic lifting matrix is an identity matrix.

Aspect 13: The method of any of Aspects 1-12, wherein the codebook is associated with a degree-2 chain, and wherein the cyclic lifting matrix is an identity matrix for 0 cyclic shift values in the degree-2 chain and is the identity matrix for 1 values in a parity column associated with the codebook.

Aspect 14: The method of any of Aspects 1-13, wherein the codebook is associated with a degree-2 chain, and wherein the cyclic lifting matrix is an identity matrix for 0 cyclic shift values in the degree-2 chain and is the cyclic lifting matrix for non-zero values in a base graph that is assigned to the same initial matrix in connection with product lifting.

Aspect 15: The method of any of Aspects 1-14, wherein the codebook is associated with a degree-1 hybrid automatic repeat request extension node, and wherein the codebook is associated with an identity matrix for product lifting.

Aspect 16: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-15.

Aspect 17: An apparatus for wireless communication at a device, the apparatus comprising one or more memories and one or more processors coupled to the one or more memories, the one or more processors configured to cause the device to perform the method of one or more of Aspects 1-15.

Aspect 18: An apparatus for wireless communication, the apparatus comprising at least one means for performing the method of one or more of Aspects 1-15.

Aspect 19: A non-transitory computer-readable medium storing code for wireless communication, the code comprising instructions executable by one or more processors to perform the method of one or more of Aspects 1-15.

Aspect 20: A non-transitory computer-readable medium storing a set of instructions for wireless communication, the set of instructions comprising one or more instructions that, when executed by one or more processors of a device, cause the device to perform the method of one or more of Aspects 1-15.

Aspect 21: A device for wireless communication, the device comprising a processing system that includes one or more processors and one or more memories coupled with the one or more processors, the processing system configured to cause the device to perform the method of one or more of Aspects 1-15.

Aspect 22: An apparatus for wireless communication at a device, the apparatus comprising one or more memories and one or more processors coupled to the one or more memories, the one or more processors individually or collectively configured to cause the device to perform the method of one or more of Aspects 1-15.

Aspect 23: A device comprising a processing system that includes one or more processors and one or more code-storing memories coupled with the one or more processors, the processing system configured to cause the device to perform the method of one or more of Aspects 1-15.

Aspect 24: A device comprising a processing system that includes processor circuitry and code-storing memory circuitry, the processing system configured to cause the device to perform the method of one or more of Aspects 1-15.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a transmitter, comprising:
one or more memories; and
one or more processors, the one or more processors, individually or collectively and based at least in part on information stored in the one or more memories, being configured to:
generate a signal, for a set of bits, using a codebook, wherein the codebook is based on a quasi-cyclic (QC) low-density parity check (LDPC) code that is associated with a cyclic lifting matrix; and
transmit the signal using one or more antennas associated with the signal.

2. The apparatus of claim 1, wherein the codebook is based on a matrix direct product of the cyclic lifting matrix and an identity matrix with a configured cyclic shift value.

3. The apparatus of claim 2, wherein the identity matrix is a 2×2 identity matrix and, wherein the configured cyclic shift value is 0 or 1.

4. The apparatus of claim 2, wherein the identity matrix is a 4×4 identity matrix, and wherein the configured cyclic shift value is 0, 1, 2, or 3.

5. The apparatus of claim 2, wherein the identity matrix is a 2^{M}×2^{M} identity matrix, wherein the configured cyclic shift value is in a range of 0 to (2^{M})−1, and wherein M represents a configured extension multiplier of the codebook.

6. The apparatus of claim 2, wherein the matrix direct product is a Kronecker product.

7. The apparatus of claim 1, wherein the codebook is based on a replacement of an edge of a base matrix with a lifting replacement matrix, wherein the lifting replacement matrix is associated with a base graph lifted in connection with an initial cyclic lifting matrix.

8. The apparatus of claim 7, wherein the lifting replacement matrix is based on the base matrix and a cyclic shifted matrix.

9. The apparatus of claim 1, wherein the codebook is based on a first replacement of a first edge of a base matrix with a first lifting replacement matrix to generate an intermediate matrix and a second replacement of a second edge of the intermediate matrix with a second lifting replacement matrix.

10. The apparatus of claim 1, wherein the codebook is based on the cyclic lifting matrix in connection with a configured maximum codebook size.

11. The apparatus of claim 1, wherein the codebook is based on the cyclic lifting matrix in connection with a matrix dimension size satisfying a threshold.

12. The apparatus of claim 1, wherein a cyclic shift value of the cyclic lifting matrix is 0, and wherein the cyclic lifting matrix is an identity matrix.

13. The apparatus of claim 1, wherein the codebook is associated with a degree-2 chain, and wherein the cyclic lifting matrix is an identity matrix for 0 cyclic shift values in the degree-2 chain and is the cyclic lifting matrix for non-zero values in a base graph that is assigned to the same initial matrix in connection with product lifting.

14. The apparatus of claim 1, wherein the codebook is associated with a degree-1 hybrid automatic repeat request extension node, and wherein the codebook is associated with an identity matrix for product lifting.

15. A method of wireless communication performed by a transmitter, comprising:
generating a signal, for a set of bits, using a codebook, wherein the codebook is based on a quasi-cyclic (QC) low-density parity check (LDPC) code that is associated with a cyclic lifting matrix; and
transmitting the signal using one or more antennas associated with the signal.

16. The method of claim 15, wherein the codebook is based on a matrix direct product of the cyclic lifting matrix and an identity matrix with a configured cyclic shift value.

17. The method of claim 16, wherein the identity matrix is a 2×2 identity matrix and, wherein the configured cyclic shift value is 0 or 1.

18. The method of claim 16, wherein the identity matrix is a 4×4 identity matrix, and wherein the configured cyclic shift value is 0, 1, 2, or 3.

19. The method of claim 16, wherein the identity matrix is a 2^{M}×2^{M} identity matrix, wherein the configured cyclic shift value is in a range of 0 to (2^{M})−1, and wherein M represents a configured extension multiplier of the codebook.

20. A non-transitory computer-readable medium storing a set of instructions for wireless communication, the set of instructions comprising:
one or more instructions that, when executed by one or more processors of a transmitter, cause the transmitter to:
generate a signal, for a set of bits, using a codebook, wherein the codebook is based on a quasi-cyclic (QC) low-density parity check (LDPC) code that is associated with a cyclic lifting matrix; and
transmit the signal using one or more antennas associated with the signal.
